(19) United States
(12) Patent Application Publication
(10) Pub. No.: US 2008/0053770 A1
(43) Pub. Date: Mar. 6, 2008

(54) Travel case for a portable electronic device

(76) Inventor: Timothy Tynyk, Ashburn, VA (US)

Correspondence Address: KED & ASSOCIATES, LLP, P.O. Box 221200, Chantilly, VA, 20153-1200, US

(21) Appl. No.: 11/513,155

(22) Filed: Aug. 31, 2006

(51) Int. Cl. A45C 3/02; H01M 2/10

(52) U.S. Cl. 190/100; 190/102; 429/96

(57) ABSTRACT

A travel case for a portable electronic device is provided. The travel case includes a case body, the case body having a portable electronic device receiving portion configured to receive and snuggly fit therein a portable electronic device, a docking device provided in the case body, and a power adapter provided in the case body.

### BACKGROUND OF THE INVENTION

1. Field of the Invention

A travel case for a portable electronic device is disclosed.

2. Background of the Related Art

Portable electronic devices, such as portable media players, have increased in popularity recently. Such portable media players often have accessories that a user needs to carry with him/her when traveling.

For example, portable media players often have docking systems for connecting the portable media player to, for example, a computer or other media player, such as a DVD player, sound system, or television.

Further, portable media players may require a power adapter for connecting the portable media player to a power source, such as a wall power outlet, for re-charging. The power adapter may be configured to receive plugs corresponding to the power system of different countries to which the user travels.

Carrying such accessories as individual pieces is cumbersome. Further, the individual pieces, as well as the portable media player, may easily become lost or damaged.

### BRIEF DESCRIPTION OF THE DRAWINGS

Embodiments will be described in detail with reference to the following drawings in which like reference numerals refer to like elements wherein:

FIG. 1A is a perspective top view of a travel case for a portable electronic device according to an embodiment, showing the travel case in an open state;

FIG. 1B is a perspective top view of the travel case of FIG. 1A, showing the travel case in a closed state;

FIG. 1C is a block diagram of electronic components of a travel case according to an embodiment;

FIG. 1D shows an exemplary insert according to an embodiment;

FIG. 1E is an end view of a travel case according to an embodiment, showing the travel case in a closed state;

FIG. 1F is an end view of a travel case according to an embodiment, showing the travel case in an open state;

FIG. 1G is a bottom view of the first case member of the travel case of FIG. 1A;

FIG. 2 is a bottom view of the travel case of FIG. 1A, showing the travel case in a closed state;

FIG. 3 is a side view of the travel case of FIG. 1A, showing the travel case in a closed state;

FIG. 4 is a side view of the travel case of FIG. 1A, showing the travel case in a closed state;

FIG. 5A is a front perspective view of the travel case of FIG. 1A, showing the travel case sitting upright on a flip stand;

FIG. 5B is a rear perspective view of the travel case of FIG. 1A, showing the travel case sitting upright on a flip stand;

FIGS. 6A-6C show a flip stand detent mechanism according to an embodiment;

FIG. 7A is a perspective top view of a travel case for a portable electronic device according to another embodiment, showing the travel case in an open state;

FIG. 7B is a block diagram of electronic components of a travel case according to another embodiment;

FIG. 8 is a perspective top view of the travel case of FIG. 7A, showing the travel case in a closed state;

FIG. 9 is a top view of the second case member of the travel case of FIG. 7A, showing an exemplary portable electronic device, in this case a portable media player, disposed adjacent the travel case;

FIG. 10 is a top view of the second case member of the travel case of FIG. 7A, showing an exemplary portable electronic device, in this case a portable media player, disposed within the second case member;

FIG. 11 is a top perspective view of the second case member of the travel case of FIG. 7A;

FIG. 12 is a bottom view of the second case member of the travel case of FIG. 7A;

FIG. 13 is an end view of the travel case of FIG. 7A, showing the travel case in a closed state;

FIG. 14 is a side view of the travel case of FIG. 7A, showing the travel case in a closed state;

FIG. 15 is a bottom view of a travel case according to an embodiment having an alternative connector cable retraction device;

FIG. 16, is a front view of the travel case of FIG. 7A, showing the travel case in an open state and connected to an exemplary wall power outlet;

FIG. 17 is a drawing of a connector cable according to an embodiment; and

FIG. 18 is a perspective view of a travel case according to another embodiment.

### DETAILED DESCRIPTION

Embodiments are directed to a travel case for a portable electronic device. It should be understood that various embodiments are disclosed by way of example, and that features of the various embodiments may be combined in various combinations to produce a travel case with a desired combination of features. Also, locations of the various features may vary. The embodiments are discussed herein with reference to an exemplary portable media player, in this case a portable MP3 player, such as an iPOD™. However, one of ordinary skill in the art will recognize that the embodiments may be utilized with other portable media players, including but not limited to portable media players from companies such as iriver, Creative, Samsung, Philips, Archos, MicroSoft and SanDisk, as well as other portable electronic devices, such as portable play stations, portable entertainment devices (PEDs), portable display apparatus (PDAs), portable handheld computers, navigation systems, and portable communication devices.

Embodiments integrate into a stylish, highly portable, and compact travel case components, including but not limited to a docking device, a power adapter, a composite audio/video output jack, and a S-video output jack. The power adapter may include removable/interchangeable plugs. The travel case may further integrate a connector cable, such as a USB or FireWire™ cable. The travel case may provide a housing for a connector cable, such as a USB or FireWire™ cable.

The travel case may include first and second case members. The first and second case members may be attached, for example, by a connecting device, such as a hinge device. The various components, including but not limited to a docking device, a power adapter with or without removable/interchangeable plugs, a connector cable, such as a USB or FireWire™ cable, a composite audio/video output jack, and/or an S-video output jack may be housed in the second case member. Further, the second case member may include a portable electronic device receiving portion configured to receive and snuggly fit a portable electronic device. The portable electronic device receiving portion may include a docking connector which connects the portable electronic device to the docking device.

Additionally, the travel case may be provided with remote capability. Further, the travel case may include a pass-through connector configured to allow a connector cable, such as a USB or FireWire™ cable, to be connected to the travel case, as well as the docking device and/or power adapter therein. Furthermore, the travel case may include an integrated/replaceable battery.

The travel case may be made out of a variety of materials, including but not limited to various synthetics, such as plastic and vinyl, leather, and metal. Further, the travel case may include interchangeable shells, skins, and/or faceplates. For example, interchangeable face plates may be inserted into the first case member, which in such a case may be transparent, to change a color and/or design of the first case member. The face plates may be held in place to an inner surface of the first case member by retaining members, such as clips, which may be formed integral with the first case member.

The travel case may include one or more windows to allow portions of the portable electronic device to be accessed, operated and/or viewed therethrough. For example, the travel case may include one or more transparent windows to allow portions of the portable electronic device to be viewed therethrough. Further, the travel case may include one or more open windows to allow portions of the portable electronic device to be accessed and/or operated therethrough. Alternatively, the travel case may include one or more flexible membranes to allow portions of the portable electronic device to be accessed and/or operated therethrough. Alternatively, the travel case may include one or more windows with slidable covering. Further, various elements may be movably mounted on the travel case such that the movable elements are operable from outside the travel case, and such that interior portions of the movable elements operate various buttons on a device mounted inside the travel case.

The docking device may include a docking connector disposed in the portable electronic device receiving area. The docking connector may be tilted slightly upward to allow for easy connection to a portable electronic device. Such a connector may also be movable to allow connection to the device as it is inserted into the travel case.

The portable electronic device receiving area may include filler material for receiving and cushioning the portable electronic device. Further, the filler material may be memory foam provided to cushion the portable electronic device and allow the travel case to house portable electronic devices of varying size, providing cushioning and/or a snug fit. Alternatively, an insert may be provided to allow the portable electronic device receiving area to receive and provide cushioning and/or a snug fit for portable electronic devices of varying size. In other words, a travel case may be provided with multiple sets of cushion materials, each of which is designed to fit a different type of electronic device. This would allow a user to customize the travel case for the exact type of device that the user wishes to place in the travel case.

In addition to the docking device, the travel case may include a connector cable, such as a USB or FireWire™ cable, which allows the travel case, docking device, and portable electronic device therein to connect to, for example, a computer, various audio components, speaker systems, displays, projectors, or other electronic devices. The travel case may provide a housing area for the connector cable. The housing may comprise a closable compartment with or without a tree for winding the cable thereon. The travel case may further include a connector cable retraction device. The connector cable retraction device may be configured to accommodate a spring-loaded retractable cable. Alternatively, the connector cable retraction device may be configured to retract thereinto a connector cable equivalent in length to the travel case. The connector cable may be held in place by magnets.

The travel case may also include a composite audio/video output jack, an S-video outlet jack, or some other type of output jack, which allows the travel case, docking device, and portable electronic device disposed therein to connect, for example, to a display device, a video player/recorder, such as a DVD player, or other electronic devices. Additionally, the travel case may include a connector jack for a connector cable, such as a USB or FireWire™ cable.

The power adapter may include a plug for attaching to a conventional wall outlet. Alternatively, the power adapter may include a plug receiving portion and multiple removable/interchangeable plugs. The plug receiving portion may be configured to receive various adapter plugs, which allow the travel case to adapt to the power systems of various different countries to which a user travels.

The travel case may also include a flip stand mechanism. The stand mechanism may include a flip stand and a detent mechanism configured to allow the flip stand to be rotated to a desired angle and locked in place at that angle.

Additionally, one end portion of the second case member may be wider than another end portion of the second case member such that the travel case may sit on a substantially flat surface and provide a view angle for viewing a portable media player mounted in the travel case.

Embodiments of the travel case will now be discussed in detail with reference to the accompanying figures, in which like reference numeral have been used to indicate like elements.

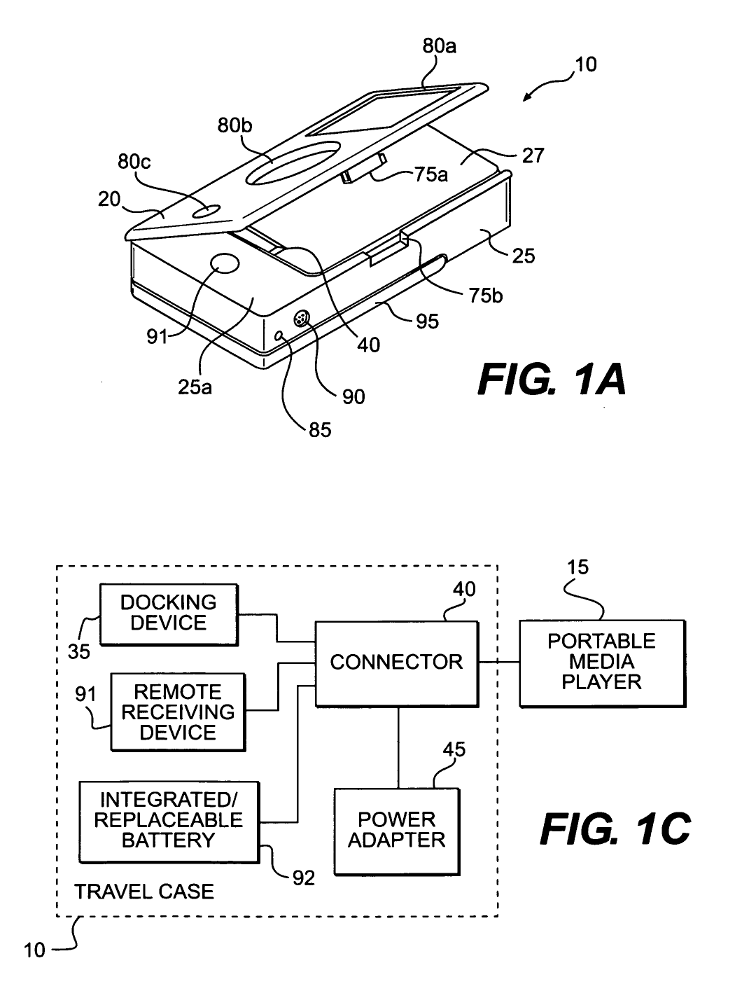

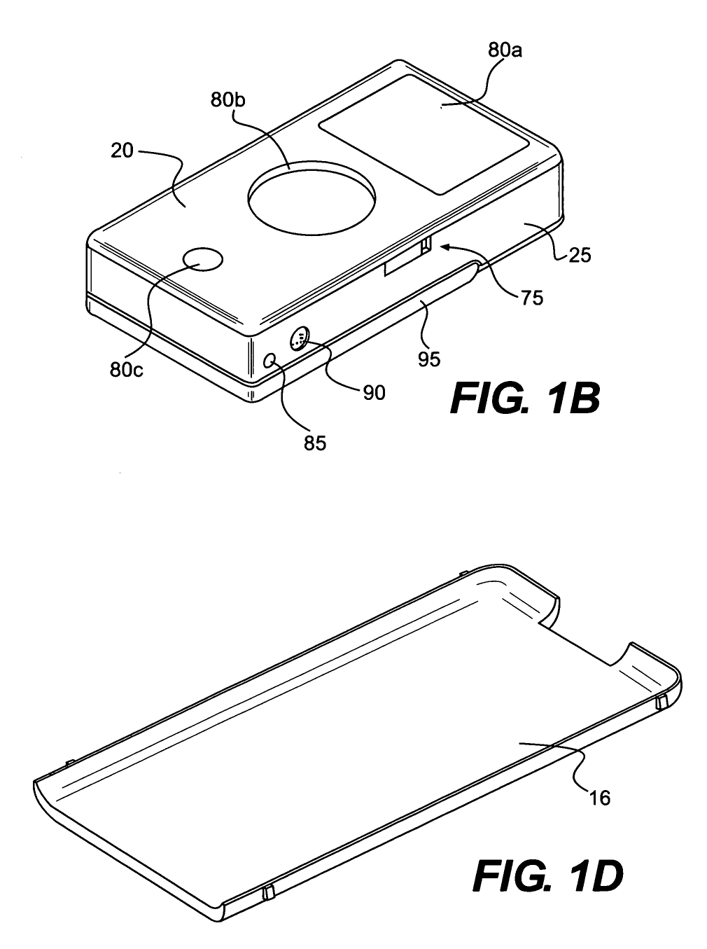

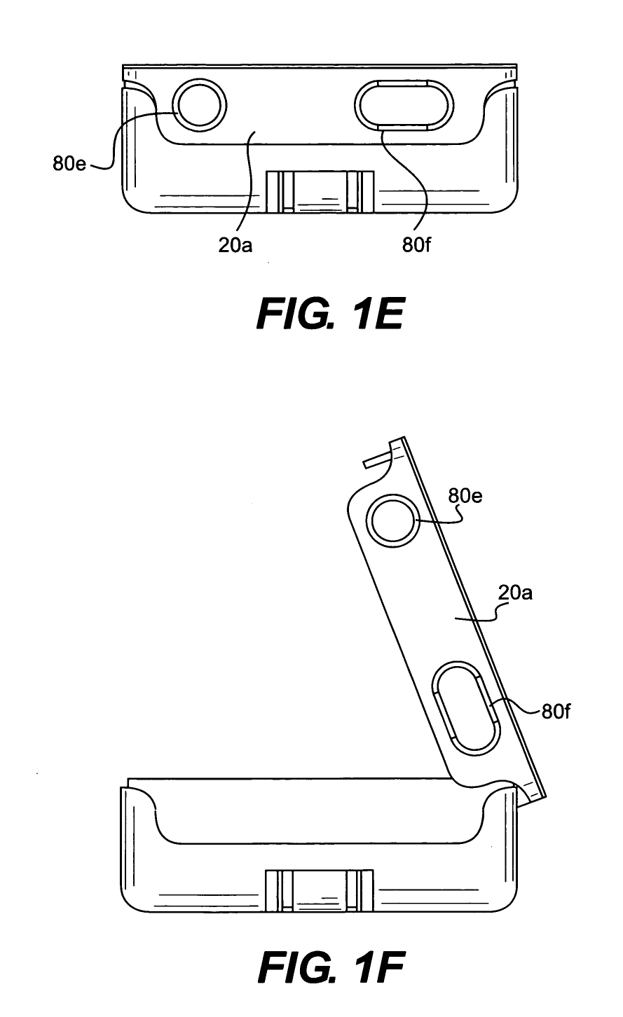

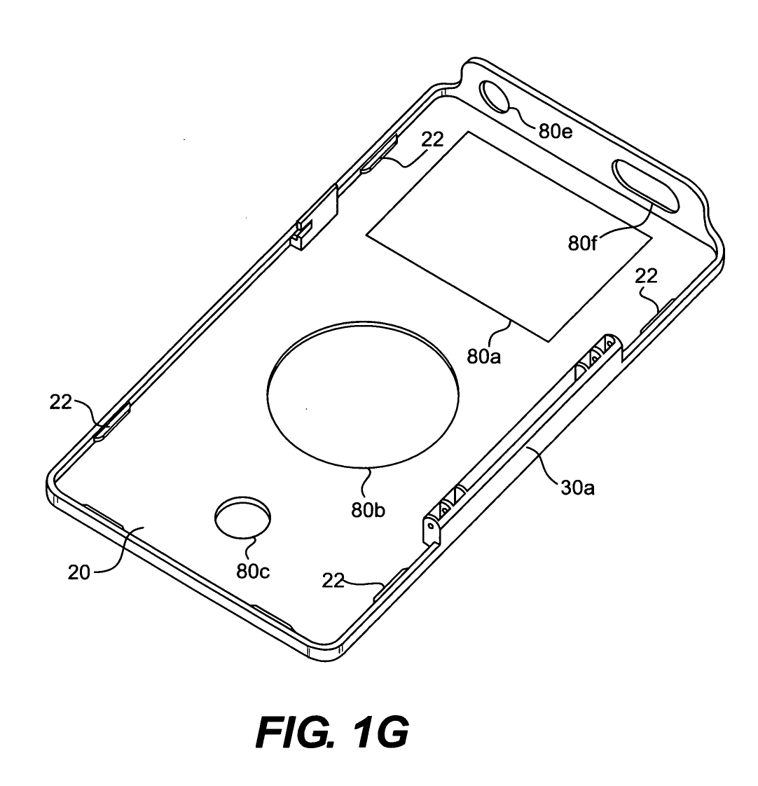

FIG. 1A is a perspective top view of a travel case for a portable electronic device, according to an embodiment, in this case a portable media player, showing the travel case in an open state. FIG. 1B is a perspective top view of the travel case of FIG. 1A, showing the travel case in a closed state. FIG. 1C is a block diagram of electronic components of a travel case according to an embodiment. FIG. 1D shows an exemplary insert according to an embodiment. FIG. 1E is an end view of a travel case according to an embodiment, showing the travel case in a closed state. FIG. 1F is an end view of a travel case according to an embodiment, showing the travel case in an open state. FIG. 1G is a bottom view of the first case member of the travel case of FIG. 1A.

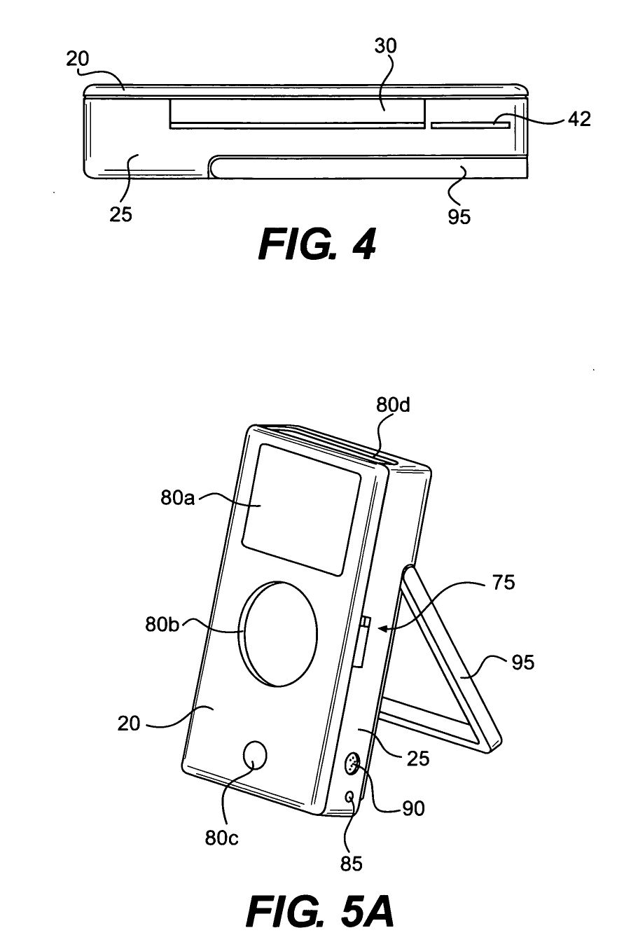

As shown in FIG. 1A, the travel case 10 may include first and second case members 20, 25. The first and second case members 20, 25 may be connected by a connection device 30, such as a hinge device, as shown in FIG. 4. The connection device 30 may include first and second connection members 30a, 30b. A latch 75, as shown in FIGS. 1A, 1B, 2, 3, and 5A, which may include mating first and second latch portions 75a, 75b, may be provided to secure the travel case in the closed state. For example, the latch 75 may include a first latch portion 75a including a protrusion with a retractable portion attached to the first case member 20 configured to mate with a second latch portion 75b comprising a slot and hole formed in the second case member 25.

The second case member 25 may include a docking device 35 and a power adapter 45 encased with a housing portion 25a of the second case member 25. Additionally, the second member 25 may incorporate a remote receiving device 91. The second case member 25 may also include an integrated/replaceable battery 92. As shown in FIG. 1C, the docking device 35 and power adapter 45, as well as the remote receiving device 91, and the integrated/replaceable battery 92, may be electronically coupled to a portable media device 15 by means of a connector 40.

The second case member 25 may further include an electronic device receiving portion 27, for receiving therein a portable electronic device 15. The electronic device receiving portion 27 may be configured to fit a particular electronic device, for example, a portable media player of a particular size. Further, an insert 16, as shown in FIG. 1D, may be provided to allow the electronic device receiving portion 27 to receive an electronic device of a different size and/or shape and still cushion and/or provide a tight fit for the respective portable electronic device. The insert may be formed of, for example, synthetic materials, such as plastic or rubber.

Alternatively, as discussed with other embodiments, the electronic device receiving portion 27 may include a filler material, such as a material to cushion and/or provide a tight fit for the portable electronic device. The filler material may be, for example, a memory foam which could allow the portable electronic device receiving portion to receive portable electronic devices of varying size and still cushion and/or provide a tight fit for the respective portable electronic device.

The travel case 10, including first and second case members 20, 25, may be made of any types of material, including but not limited to plastic, leather, or metal. For example, the travel case may be formed of molded plastic. Further, the travel case, including first and second case members 20, 25, may include any color, design, and/or ornamentation according to a user's desire. Alternatively, the travel case may include interchangeable shells, skins, and/or face plates. For example, interchangeable face plates may be inserted into the first case member 20, which in such a case may be transparent, to change a color and/or design of the first case member 20. As shown in FIG. 1G, the face plates may be held in place to an inner surface of the first case member 20 by retaining members, such as clips 22, which may be formed integral with the first case member 20.

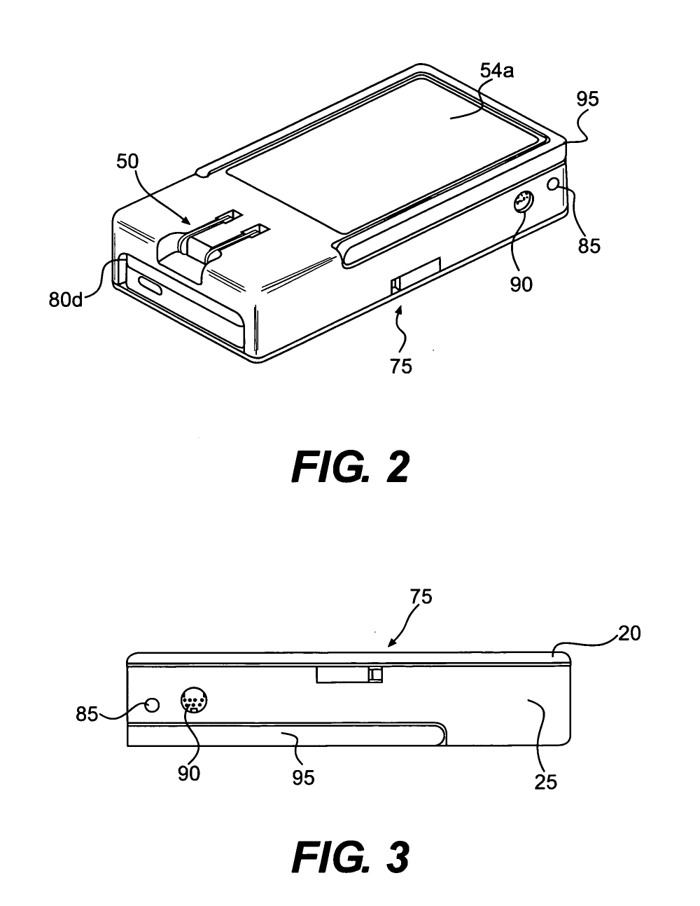

The first case member 20 may include one or more openings or windows 80a, 80b, 80c, 80d. The window(s) may be open to allow access therethrough to portions of the portable electronic device 15, or may be made of a transparent and/or flexible material or film. For example, the window 80a may be configured to allow access and/or viewing to a display of a portable media player, such as an iPOD™. The window 80b may be configured to allow access to a touch screen or input device of a portable media player, such as an iPOD™. A further opening 80c may be provided to allow an infrared or wireless signal to be received by the remote (i.e., wireless or infrared) receiving device 91 housed therein. As shown in FIG. 2, a further window 80d may be provided to allow access to an upper portion of a portable media player. Such opening may allow access to an audio (or earphone) jack and a locking switch provided on the portable electronic device. The second case member 25 may also include such openings.

Alternatively, instead of the window 80d, the first case member 20 may include a vertically extending side wall 20a, as shown in FIGS. 1E and 1F, provided with openings 80e and 80f for access to an audio (or earphone) jack and a locking switch provided on the portable electronic device.

The docking device 35 may include a docking connector 40 provided in the portable electronic device receiving portion 27 for connecting to the portable electronic device 15. The docking connector 40 may be attached to a ribbon wire or circuit (i.e., printed circuit board (PCB)) (not shown) embedded in the second case member 25 for connection to other components. As shown in FIG. 1A, the docking connector 40 may be tiltable with respect to a longitudinal axis of the travel case 10 to allow easy connection of the portable electronic device 15 thereto.

The power adapter 45 may include a plug 50 configured to mate with a conventional power outlet, as shown in FIG. 2. Alternatively, the power adapter 45 may include removable/interchangeable plugs configured to mate with a wall power outlet, as later discussed with respect to other embodiments. In such a case, the multiple plugs may correspond to respective plugs adapted to mate with electric systems of various countries to which the user may travel.

The travel case 10 may include a connector jack 42 for a connector cable, such as a USB or FireWire™ cable. In FIG. 4, the connector jack 42 is shown on an upper side of the travel case 10. However, other locations may also be appropriate.

The second case member 25 may further include a compartment 54 for storing a connector cable, such as a USB or FireWire™ cable, or other accessories in a compact fashion. The compartment may include a removable door 54a.

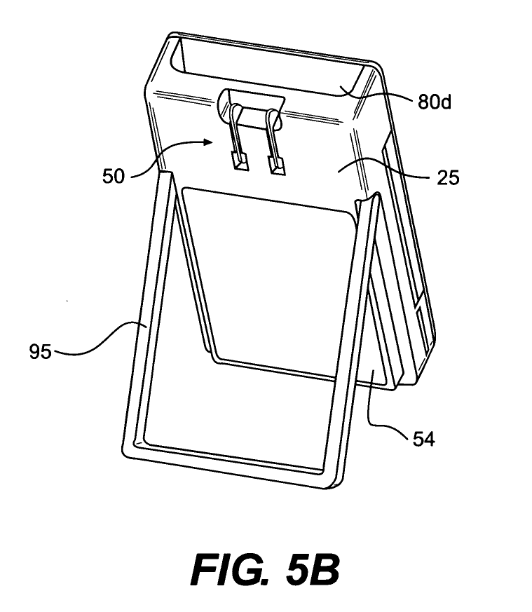

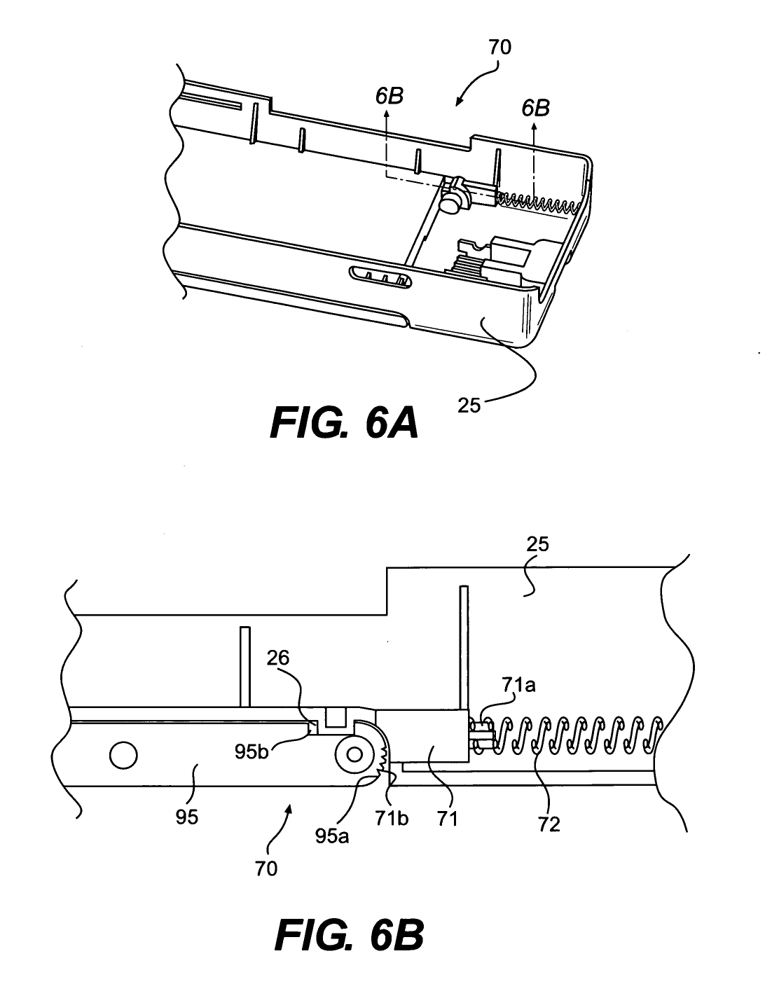

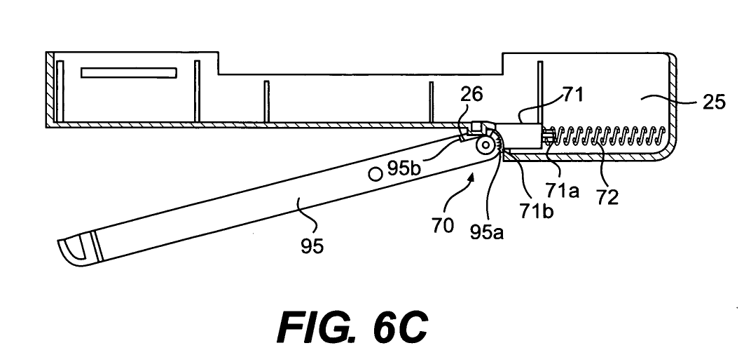

The travel case 10 may further be provided with a stand 95, as shown in FIGS. 2-6. The stand 95 allows the travel case 10 to be propped up, as shown in FIGS. 5-6 for easy viewing by a user. The stand may be configured to adjust to various angles, such as 15°, 30°, 45°, with respect to a central longitudinal axis of the travel case.

That is, the stand may be attached to the travel case 10 by means of a detent mechanism 70, as shown in FIGS. 6A-C. The detent mechanism 70 may include a base member 71 having a protrusion 71a spring-mounted (via spring 72) to the second case member 25 of the travel case 10. The base member 71 may further include a detent 71b configured to mate with detent grooves 95a on the stand 95. The stand 95 may further include a groove 95b configured to mate with a protrusion 26 provided on the second case member 25.

To operate, the mating grooves 95b and protrusion 26 allow the stand 95 to be pulled in a longitudinal direction, which allows the detent 71b to disengage from detent groove 95a and the stand to be rotated to a desired angle where the detent 71b engages with another detent groove 95a to lock the stand at a desired angle. The detent mechanism in FIGS. 6A-6C includes four detent grooves 95a; however, another number of detent grooves may be appropriate.

The second case member 25 may further include a composite audio/video outlet jack 85 configured to allow the travel case, docking device, and portable electronic device disposed therein to connect, for example, to a display device, a video player/recorder, such as a DVD player, or other electronic devices. Additionally, the second case member 25 may include an S-video outlet jack 90, which is also configured to allow the travel case, docking device, and portable electronic device disposed therein to connect, for example, to a display device, a video player/recorder, such as a DVD player, or other electronic devices. In the embodiment of FIGS. 1A-6C, the composite audio/video outlet jack and S-video outlet jack 90 are shown located on a lower side wall of the travel case. However, other locations for these jacks may also be appropriate.

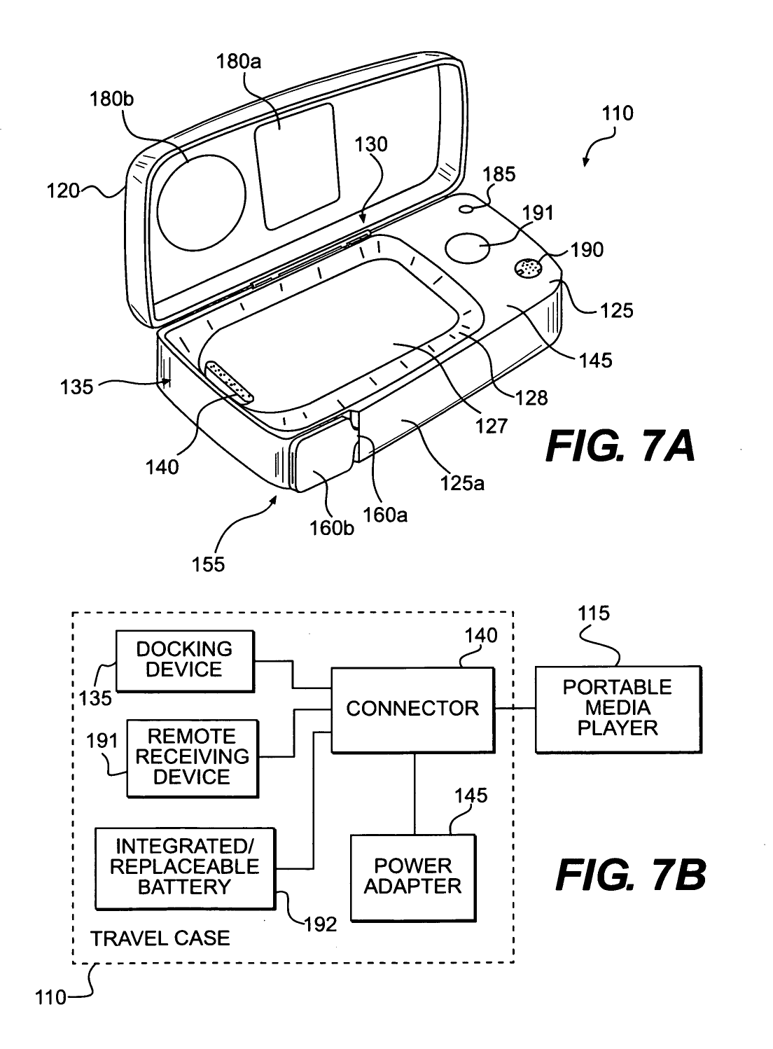

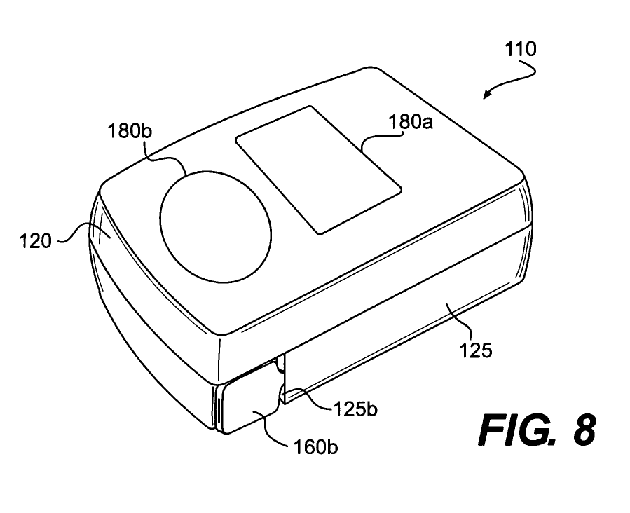

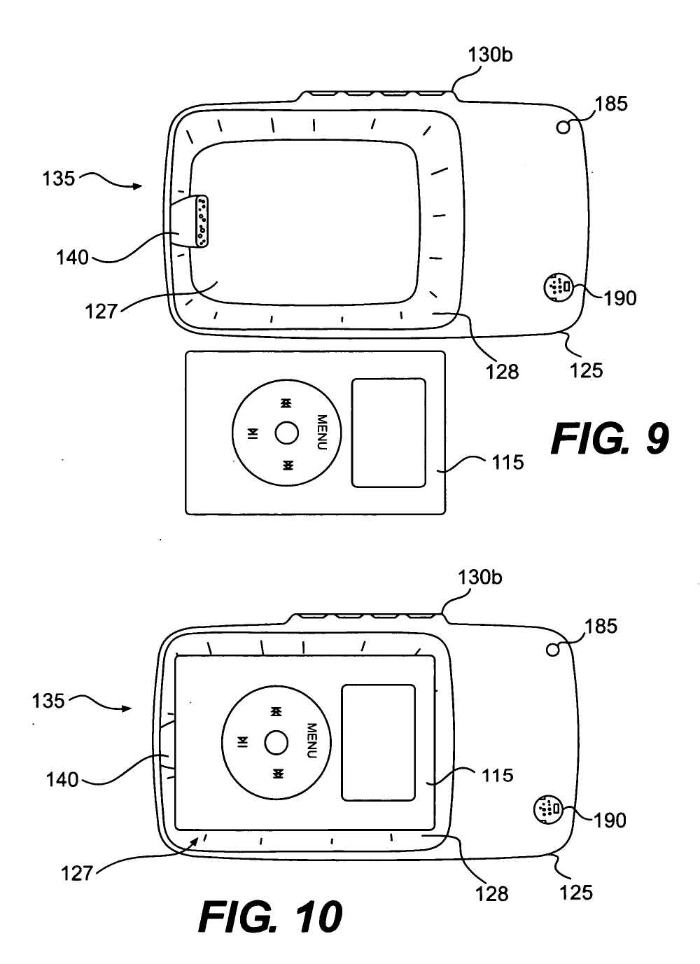

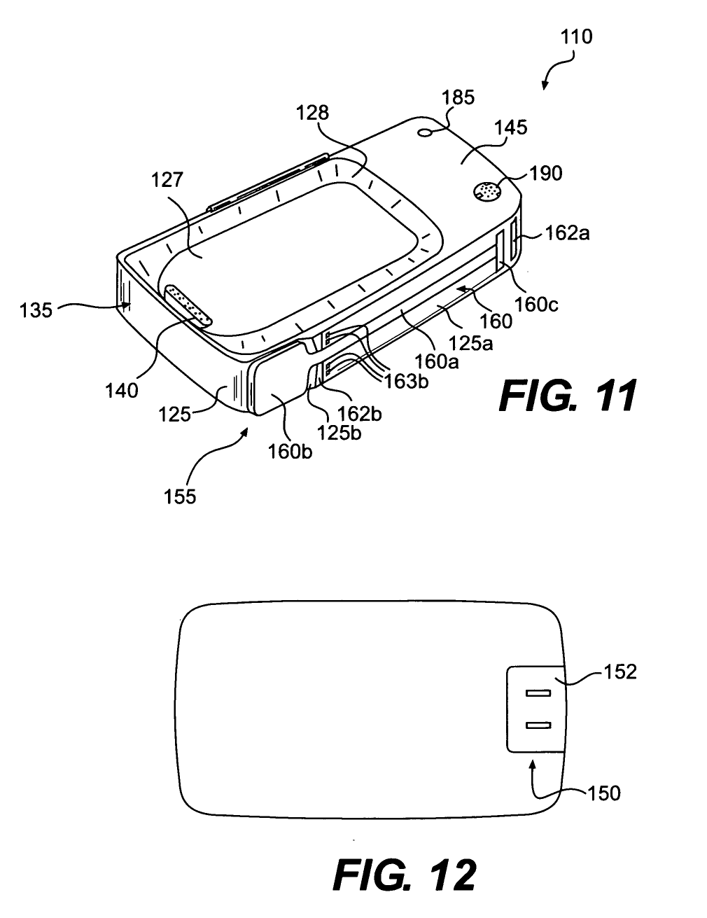

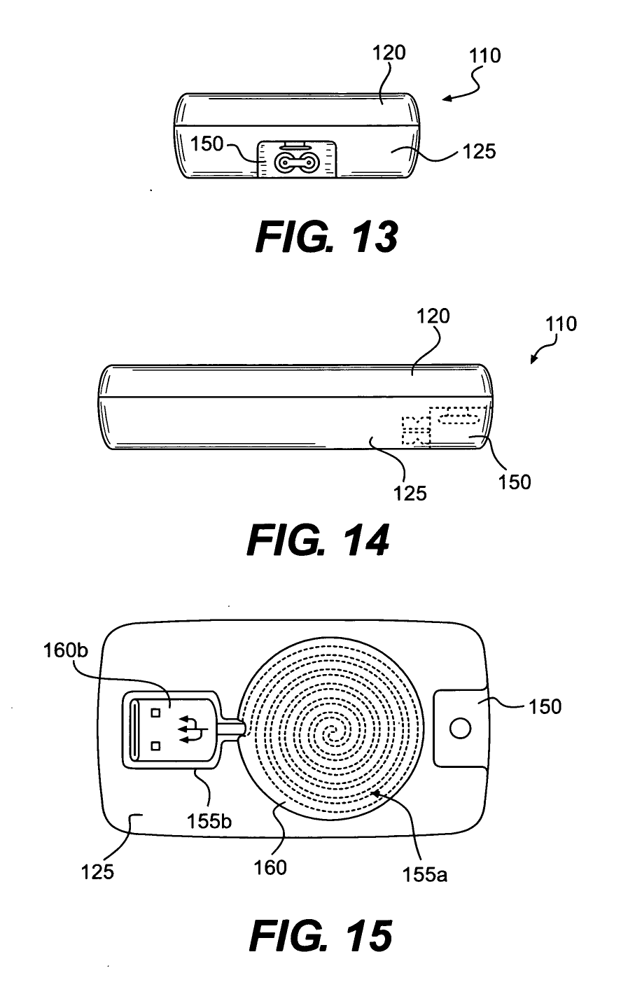

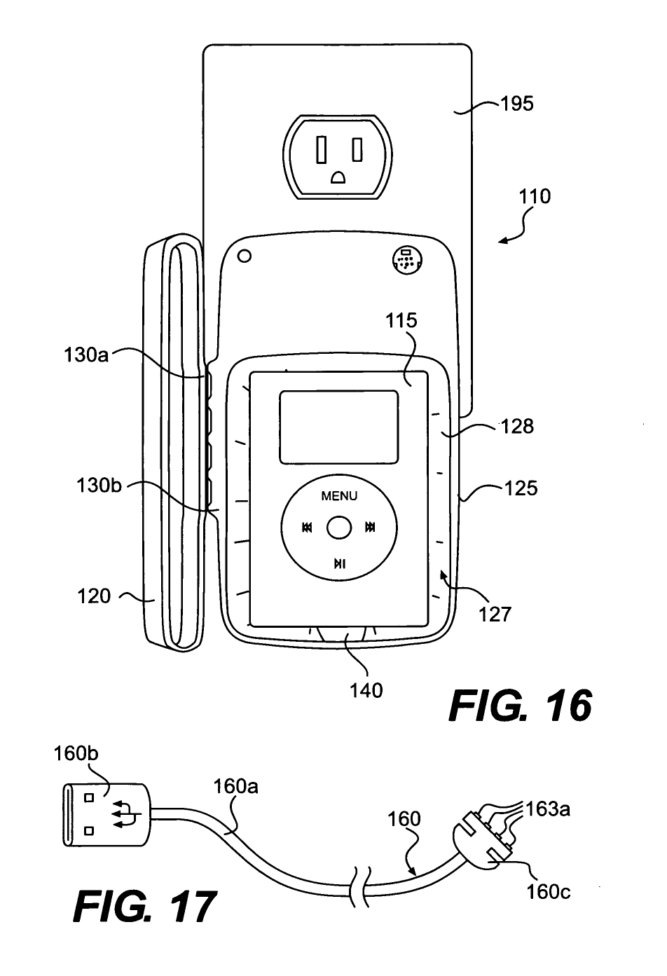

FIG. 7A is a perspective top view of a travel case for a portable electronic device according to another embodiment, showing the travel case in an open state. FIG. 7B is a block diagram of electronic components of a travel case according to an embodiment. FIG. 8 is a perspective top view of the travel case of FIG. 7A, showing the travel case in a closed state. FIG. 9 is a top view of the second case member of the travel case of FIG. 7A, showing an exemplary portable electronic device, in this case a portable media player, disposed adjacent the travel case. FIG. 10 is a top view of the second case member of the travel case of FIG. 7A, showing an exemplary portable electronic device, in this case a portable media player, disposed within the second case member. FIG. 11 is a top perspective view of the second case member of the travel case of FIG. 7A. FIG. 12 is a bottom view of the second case member of the travel case of FIG. 7A. FIG. 13 is an end view of the travel case of FIG. 7A, showing the travel case in a closed state. FIG. 14 is a side view of the travel case of FIG. 7A, showing the travel case in a closed state. FIG. 15 is a bottom view of a travel case according to an embodiment having an alternative connector cable retraction device. FIG. 16 is a front view of the travel case of FIG. 7A, showing the travel case in an open state and connected to an exemplary wall power outlet. FIG. 17 is a drawing of a connector cable according to an embodiment.

As set forth above, FIG. 7A is a perspective top view of a travel case for a portable electronic device according to another embodiment, in this case a portable media player, showing the travel case in an open state. As shown in FIG. 7A, the travel case 110 may include first and second case members 120, 125. The first and second case members 120, 125 may be connected by a connection device 130, such as a hinge device. The hinge device 130 may include first and second hinge portions 130a, 130b as shown in FIG. 16.

The second case member 125 may include a docking device 135 and a power adapter 145 encased within a housing portion 125a of the second case member 125. Additionally, the second case member 25 may incorporate a remote receiving device 191. The second case member 125 may also include an integrated/replaceable battery 192. As shown in FIG. 7B, the docking device 135 and power adapter 145, as well as the remote receiving device 191 and the integrated/replaceable battery 192, may be electronically coupled to a portable media device 115 by means of a connector 140.

The second case member 125 may further include an electronic device receiving portion 127, for receiving therein a portable electronic device 115. The electronic device receiving portion 127 may include a filler material 128, such as a material to cushion and/or provide a tight fit for the portable electronic device 115. Further, the filler material may be, for example, a memory foam which could allow the portable electronic device receiving portion 127 to receive portable electronic devices of varying size and still cushion and/or provide a tight fit for the respective portable electronic device.

The travel case 110, including first and second case members 120, 125, may be made of any types of material, including but not limited to plastic, leather, or metal. For example, the travel case may be formed of molded plastic. Further, the travel case, including first and second case members 120, 125, may include any color, design, and/or ornamentation according to a user's desire. Alternatively, the travel case may include interchangeable shells, skins, and/or face plates. For example, interchangeable face plates may be inserted into the first case member 120, which in such a case may be transparent, to change a color and/or design of the first case member 120. As discussed with other embodiments, the face plates may be held in place to an inner surface of the first case member by retaining members, such as clips, formed integral with the first case member 120.

The first case member 120 may include one or more windows 180a, 180b. The window(s) may be open to allow access therethrough to portions of the portable electronic device 115, or may be made of a transparent and/or flexible material or film. For example, the window 180a may be configured to allow access and/or viewing to a display of a portable media player, such as an iPOD™. The window 180b may be configured to allow access to a touch screen or input device of a portable media player, such as an iPOD™.

As set forth above, the docking device 135 may include a docking connector 140 provided in the portable electronic device receiving portion 127 for connecting to a portable electronic device 115. The docking connector 140 may be attached to a ribbon wire or circuit (not shown) embedded in the lower case 125 for connection to other components. As shown in FIG. 7A, the docking connector 140 may be tiltable with respect to a longitudinal axis of the travel case 110 to allow easy connection of the portable electronic device 115 thereto.

The power adapter 145 may include a plug receiving portion 150, as shown in FIGS. 12-15, configured to receive removable/interchangeable plugs 152 configured to mate with a wall power outlet 195, such as that shown in FIG. 16. The removable/interchangeable plugs may correspond to respective plugs adapted to mate with electric systems of various countries to which the user may travel.

The second case member 125 may further include a retractable connector cable device 155 for a cable 160. The retractable connector cable device 155 may store a connector cable 160, such as a USB or FireWire™ cable, in a retracted, compact fashion.

In one embodiment, the connector cable 160 is designed to be equal in length to a longitudinal length of the travel case 110. As shown in FIG. 11, which shows a cut-away view of a retractable connector cable device 155 according to one embodiment, the cable portion 160a is stored within a side wall 125a of second case member 125. A connector portion 160b of the connector cable 160 is provided in a receiving area 125b of the side wall 125a accessible to a user for withdrawing the connector cable 160 out of the travel case 110. When disposed within the travel case 110, the connector cable 160 may be held in place by a first magnet 162a, which magnetically attracts a base end 160c of the connector cable 160. In such a case, when a user withdraws the connector cable 160 from the travel case 110, the connector cable 160 is held in place by second magnet 162b. In the withdrawn position, connectors 163a provided on the base end 160c of the connector cable 160 mate with connectors 163b provided on the second case member 125.

In another alternative embodiment, the connector cable is housed in a spring-loaded, retracted, compact fashion in a retractor connector cable device 155a in the second case member 125, as shown in FIG. 15. A groove 155b may be provided for the connector portion 160b.

The second case member 125 may further include a composite audio/video outlet jack 185 configured to allow the travel case, docking device, and portable electronic device disposed therein to connect, for example, to a display device, a video player/recorder, such as a DVD player, or other electronic devices. Additionally, the second case member 125 may include an S-video outlet jack 190, which is also configured to allow the travel case, docking device, and portable electronic device disposed therein to connect, for example, a display device, a video player/recorder, such as a DVD player, or other electronic device. In the embodiment of FIGS. 7A-17, the composite audio/video outlet jack and S-video outlet jack are shown located on a lower front wall of the second case member of the travel case. However, other locations for these jacks may also be appropriate.

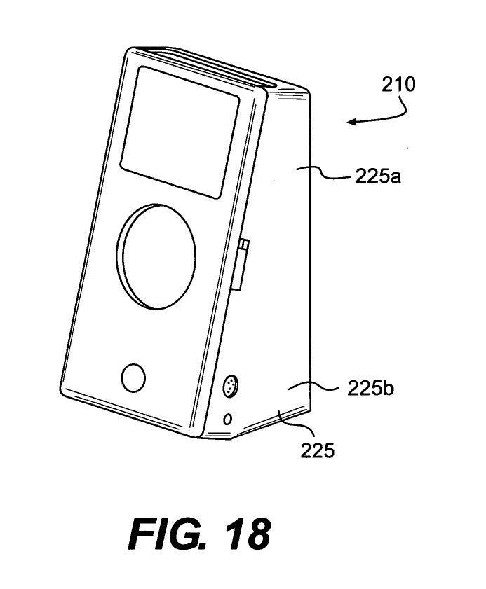

FIG. 18 is a perspective view of a travel case according to another embodiment. In the travel case 210 of FIG. 18, the second case member 225 is formed with a wider base portion 225b than top 225a to allow the travel case 210 to sit on a substantially flat surface and provide a view angle for viewing the portable media player by a user.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this invention. Mote particularly, reasonable variations and modifications are possible in the component parts and/or arrangements of the subject combination arrangement within the scope of the foregoing disclosure, the drawings and the appended claims without departing from the spirit of the disclosure. In addition to variations and modifications in the component parts and/or arrangements, alternative uses will also be apparent to those skilled in the art.

What is claimed is:

1. A travel case for a portable electronic device, comprising:
a case body, the case body having a portable electronic device receiving portion configured to receive and snuggly fit therein a portable electronic device;
a docking device provided in the case body; and
a power adapter provided in the case body.

2. The travel case of claim 1, wherein the case body comprises first and second case members.

3. The travel case of claim 2, wherein one end portion of the second case member is wider than another end portion of the second case member such that the travel case may sit on a substantially flat surface and provide a view angle for viewing a portable media player mounted in the travel case.

4. The travel case of claim 2, further comprising a removable face plate configured to be attached to one of the first and second case members.

5. The travel case of claim 4, wherein the first case member is at least partially formed of a transparent material and the face plate is attachable to an inner surface of the first case member.

6. The travel case of claim 2, wherein the docking device and power adapter are provided in the second case member.

7. The travel case of claim 2, wherein the first case member comprises at least one window configured to allow a portable electronic device to be viewed and/or accessed therethrough.

8. The travel case of claim 7, wherein the at least one window comprises at least one of a transparent window, a flexible membrane, or is open.

9. The travel case of claim 1, wherein the power adapter comprises a plug receiving portion configured to removably and interchangeably receive multiple plugs corresponding to power systems of various countries.

10. The travel case of claim 1, wherein the portable electronic device receiving portion comprises a filler material.

11. The travel case of claim 1, wherein the portable electronic device receiving portion comprises an insert which allows the portable electronic device receiving portion to receive and snuggly fit portable electronic devices of different sizes.

12. The travel case of claim 1, wherein a docking connector is provided in the portable electronic device receiving portion for connecting a portable electronic device to the docking device.

13. The travel case of claim 12, wherein the docking connector is tiltable upward with respect to a central longitudinal axis of the travel case.

14. The travel case of claim 1, further comprising a connector cable, and a retractable connector cable device configured to store the connector cable retracted therein in a spring-loaded fashion.

15. The travel case of claim 1, further comprising a connector cable substantially equal in length to the travel case and held in a retracted fashion by magnets within a side compartment of the travel case.

16. The travel case of claim 1, further comprising a compartment for housing at least one of accessories of a portable electronic device or a connector cable.

17. The travel case of claim 1, further comprising at least one of a composite audio/video output jack, a S-video output jack, or a connector cable jack.

18. The travel case of claim 1, further comprising an integrated/removable battery.

19. The travel case of claim 1, wherein the travel case is formed of one of plastic, leather, or metal.

20. The travel case of claim 1, further comprising a flip stand mechanism, wherein the flip stand mechanism comprises a flip stand and a detent mechanism configured to allow the flip stand to be rotated to a desired angle and locked in place at that angle.

21. The travel case of claim 1, wherein the portable electronic device receiving portion is configured to receive and snuggly fit therein a portable media player.

22. The travel case of claim 1, wherein the portable electronic device receiving portion is configured to receive and snuggly fit therein an iPOD™.

23. A travel case for a portable electronic device, comprising:
a case body, the case body having a portable electronic device receiving portion configured to receive and snuggly fit therein a portable electronic device;
a docking device provided in the case body;
a power adapter provided in the case body; and
an integrated/replaceable battery provided in the case body.

24. A travel case for a portable electronic device, comprising:
a case body, the case body having a portable electronic device receiving portion configured to receive and snuggly fit therein a portable electronic device;
a docking device provided in the case body;
a power adapter provided in the case body; and
a remote access device provided in the case body.
